(19) United States
(12) Patent Application Publication
(10) Pub. No.: US 2025/0370690 A1
(43) Pub. Date: Dec. 4, 2025

(54) MULTI DISPLAY ARRANGEMENT WITH AT LEAST TWO DISPLAY UNITS

(71) Applicant: Elektrobit Automotive GmbH, Erlangen (DE)

(72) Inventors: Thomas Franke, Laupheim (DE); Patrick Jahn, Ulm (DE); Kevin Hörsch, Schwäbisch Gmünd (DE)

(73) Assignee: Elektrobit Automotive GmbH, Erlangen (DE)

(21) Appl. No.: 19/108,085

(22) PCT Filed: Aug. 24, 2023
(86) PCT No.: PCT/EP2023/073197

§ 371 Date: Feb. 28, 2025

(30) Foreign Application Priority Data
Sep. 1, 2022 (EP) 22193441.7

(51) Int. Cl. G06F 3/14

(52) U.S. Cl. CPC G06F 3/1423

(57) ABSTRACT

A multi display arrangement includes at least two display units. A pair of the display units consists of thin display units that are arranged in an overlapping manner. The display units are optically bonded to a cover glass. At least one of the display units has a surface that is arranged at least partly with a larger distance to an adjacent surface of the cover glass than a respective surface of a respective other display unit.

### CROSS-REFERENCE TO RELATED APPLICATIONS

The present application is a National Stage Application under 35 U.S.C. § 371 of International Patent Application No. PCT/EP2023/073197 filed on Aug. 24, 2023, and claims priority from European Patent Application No. 22193441.7 filed on Sep. 1, 2022, in the European Patent Office, the disclosures of which are herein incorporated by reference in their entireties.

### TECHNICAL FIELD

The present invention is directed to a multi display arrangement, with at least two display units. The automotive “cockpit of the future” includes more surface area dedicated to displays and controls than ever before. Displays in future cars or other automotive applications are expected to be scattered across driver's seat, center console, front passenger seats and rear passenger seats. These displays, which are within easy reach of anyone in the car, allow customized access and control for infotainment systems; mirrors; heating, ventilation, and air conditioning (HVAC) components; and other features.

### BACKGROUND

Dashboard display systems are getting bigger and bigger, measuring up to 1400 mm in length, as multiple display components are housed under a single sheet of real glass. Their beautiful appearance, subtle curves and sleek lines contribute to the car's interior aesthetics, and they can be an important differentiating characteristic as consumers compare various car models. Because plastic is perceived by consumers as lower end, these displays are preferably made of high-quality glass, with no seams and small dark edges. Virtual-reality capabilities, projected displays and 3D displays are also actively being developed and launched in luxury models.

User interfaces, which include haptics and voice recognition, are also designed to reflect the unique aesthetic of each car brand and model. They must be highly customized, with highly saturated colours, fonts and icons carefully chosen and flawlessly executed. All human-machine interfaces (HMIs) must be engineered and designed to seem effortless as consumers interact with them. Three-dimensional shapes and higher-resolution performance are becoming more common as the world's automakers fight for consumers' purchases and strive to differentiate themselves.

On the horizon are even more exciting developments, including the inclusion of artificial intelligence (AI) into advanced technologies that track drivers' eye movements, recognize, and accommodate different drivers, identify changes in human emotions or expressions, and respond appropriately to any exceptions. For example, if a driver seems inattentive, AI-enabled sensors might send an alert or trigger Level 4 or Level 5 autonomous driving functionality.

There can be no doubt that smart displays represent an enormous opportunity for the world's automakers and their suppliers. At the same time, smart displays represent a difficult multidisciplinary engineering challenge that can be hard to manage. Consider all the aspects of display design and execution that must be addressed before they can be confidently launched into the consumer marketplace.

Display units usually are placed side by side. Typically, display units have a rectangular shape. If different shapes are needed, there is the option to design a new display unit (e.g., for smart watches, this goes along with very expensive initial cost for masks and tooling) or to mask parts of a bigger display unit surface by a smaller outline layout. A disadvantage is that in this case there must be space for the covered display unit area parts.

In principle, overlapping display units would be possible but due to the complex and thick back light unit stack, this is an unusual idea for integration. Further are display stacks typically around 3 mm to 10 mm in thickness, so overlapping display units would be clearly visible and not accepted by end-customers.

It is desired that display size or display outline are different (e.g., not rectangular). Thus, a new display layout needs to be found.

### BRIEF SUMMARY

According to the invention a multi display arrangement, with at least two display units is proposed,
wherein a pair of said display units consists of thin display units that are arranged in an overlapping manner, and
wherein the display units are optically bonded to a cover glass, and
wherein at least one of said display units has a surface that is arranged at least partly with a larger distance to an adjacent surface of the cover glass than a respective surface of a respective other display unit.

In an embodiment at least one of said displays has a surface that is arranged non-parallel to an adjacent surface of the cover glass. Due to the arrangement in an overlapping manner, a non-rectangular shape of the display arrangement is reached, without a need of a special shape of the used display units. Typically, but not limited to, the used display units are of rectangular shape, which allows easier and more cost-effective processing.

In an embodiment the space between display surface and adjacent cover glass surface is filled with cured liquid optically clear adhesive (sometimes also referred to as “cured LOCA”) material so that the overlapping area remains invisible and provides a high-class experience for the user where it does not interfere with the displayed information/content on the display units.

Advantageously the cover glass is provided with adjustment marks related to at least one edge of a display unit which edge is arranged either the same distance or closer to the cover glass as another of said edges of said display unit. This may ensure that a manufacturing process for a multi display arrangement can be performed very precisely by reducing occurring tolerances during the manufacturing process.

According to another aspect of the invention, a multi display arrangement, with at least two display units is proposed, wherein a pair of said display units consists of thin display units which preferably have a thickness below 1 mm, preferably in the range of 0,2 mm to 0,5 mm that are each bent and arranged next to each other along their respective bending lines.

In an embodiment of the proposed arrangement at least one of said display units is a bendable OLED panel. This is due to various advantages, as organic layers made of OLED (organic light-emitting diode; also known as organic electroluminescent diode) are thinner, more flexible, and also lighter than e.g., crystalline layers in LED (Light Emitting Diode) or LCD (Liquid Crystal Display). Furthermore, OLEDs are brighter than e.g., LEDs. This is because the organic layers of an OLED are much thinner than LEDs' corresponding inorganic crystal layers. An additional advantage of using OLEDs is that OLEDs do not require backlight and therefore do not require additional space in the back of the multi display arrangement. A further advantage is that OLEDs have a large field of view, which is typically about 170 degrees. Additionally, by using OLEDs a high detail contrast of displayed content is given. LCDs for example work by blocking light, so they have an inherent viewing obstacle from certain angles. But OLEDs produce their own light, so this typically results in having a much wider viewing range compared to LCDs for example. A further advantage of OLEDs is that these are easier to produce and therefore can be made to larger sizes.

The overlapping areas between display units define a gap. In an advantageous embodiment this gap is filled at least partly with cured liquid optically clear adhesive. As the OLED displays heat up when displaying bright colors, the overlap of two display units doubles the heat source. Therefore, the overlapping display units have no direct contact with an aluminum cooling surface that is preferably arranged in the area of the overlap or in general at the side of the display units that is opposite to the cover glass. The gaps to the cooling surface are thus covered/connected with a heat-conducting paste or a thermal adhesive. The material of the cooling surface is not limited to aluminum. Also, other suitable material like e.g., copper, magnesium, heat conducting plastics or two component parts with cooling properties are possible.

Furthermore, in the area of the overlap on the display positioned behind the other only the color “black” is displayed. “Black” means that “nothing” (=no content or information) is displayed, which consumes little to no power in an OLED and thus no heat is generated. The heat conducting material arranged in the gap transports heat away from the other display unit that overlaps the “black” part of said display unit.

Usually, each display unit of the multi display arrangement is provided with a PCB (Printed Circuit Board) attached at a connecting side of said display unit via an FPC (Flexible Printed Circuit). In a highly preferred embodiment said PCB is arranged at the backside of said display unit via said FPC being bent, and a pair of display units is arranged overlapping such that their respective PCBs would not overlap if they were bent back to lie in the same plane as their respective display unit. If this condition cannot be met for a certain desired overlap region, one of said display units may be arranged with FPC at another side, such that this condition can be met. Meeting this condition allows for laminating the overlapping display units without interfering with their respective PCBs and without interference of the PCBs with each other. After the lamination process is finished, the respective PCB is bent to the backside of it respective display unit. Due to the FPC a slight bending of the display unit can be compensated without a need to bend the respective PCB in a similar degree, or at all.

Furthermore, FPCs are so-called flexible PCBs and are therefore ideally suited for the solution proposed as it is e.g., essential that the circuits can handle the bumps and jolts that happen inside a vehicle during driving. According to the fact that FPCs are very thin they therefore do not add thickness to the overlapping area. Additionally, they are cost effective and durable, so that the probability of costly and complicated repairs due to mechanical stress on the proposed multi display arrangement can be minimized.

The proposed multi display arrangement is preferably part of an apparatus like a cockpit of a vehicle but can also be used in e.g., medical, aircraft, industrial, or consumer applications.

The cover glass of the proposed multi display arrangement is preferably made of glass. Glass is stable in shape. Curved glass is difficult to produce as e.g., curving requires a lot of energy, but an important advantage of using glass is, that it is not so easy to deform. In an alternative embodiment it can also be made of another material, such as e.g., plastic. But if the glued-on display units would like to revert to their original shape, this will be less easy with glass than with plastic.

Due to the possibility to place two display units overlapping each other, new display outline designs can be integrated without the need to develop a new display unit design. Using only a single display unit size to create the effect or the appearance of different display sizes without an invest into new display unit designs is one of the advantages of the present invention. The invention allows to achieve multiple display outline designs with a single standard display unit layout. This is possible when using thin display unit stacks, e.g., based on OLED or MicroLED (Micro Light Emitting Diode) technology.

To hide unwanted areas of the display an ink mask is applied to the back of the cover glass, a so-called black print. Every display has a non-active area without any pixels, a so-called dead band. Due to overlapping of the display units one of the dead bands can be hidden behind the other display unit. This results in smaller gaps between active areas of two neighboring display units. With this the black print gap is also smaller.

By placing thin display units partly in a stacked orientation, they are partly hidden or overlapping each other. With this idea, different display appearances can be realized with a single standard display unit size. No investigation into other additional display unit layouts is needed. This is possible when using thin display unit stacks, preferably based on OLED or MicroLED technology. These kinds of display-types do not need a backlight unit as they are actively generating light.

### BRIEF DESCRIPTION OF THE DRAWINGS

FIG. 1 shows a multi display arrangement in a vehicle cockpit according to prior art.

FIG. 2 shows an exemplary display integration using flexible display units.

FIG. 3 shows an integration of display units behind one single (3-dimenisonally (3-D) shaped) cover glass.

FIG. 4 shows a front view without and with overlapping areas and a back view of an exemplary setup of a multi display arrangement.

FIG. 5 shows a stack up of display units with a cover glass from a top view.

FIG. 6 shows an example of a possible arrangement of two display units on a cover glass.

FIG. 7 shows a 3-dimensional exploded view of a multi-display arrangement.

FIG. 8 shows an example of how a final product may look like.

FIG. 9 shows an example of a multi display arrangement where corrected UI-Pictures are displayed on the respective display units.

FIG. 10 shows an example of two display units for a working overlap.

FIG. 11 shows an example of two display units for a non-working overlap.

FIG. 12 shows a further example of two display units for a working overlap.

FIG. 13 shows a further example of two display units for a non-working overlap.

FIG. 14 shows a further example of two display units for a non-working overlap.

FIG. 15 shows a rear view of the multi display arrangement with PCBs and FPCs.

FIG. 16 shows a rear view of the multi display arrangement with arranged aluminum cooling plates at a backside.

FIG. 17 shows a display unit being bent along a bending line where the bending angle is about 90°.

FIG. 18 shows a display unit being bent along a bending line where the bending angle is about 180°.

### DETAILED DESCRIPTION

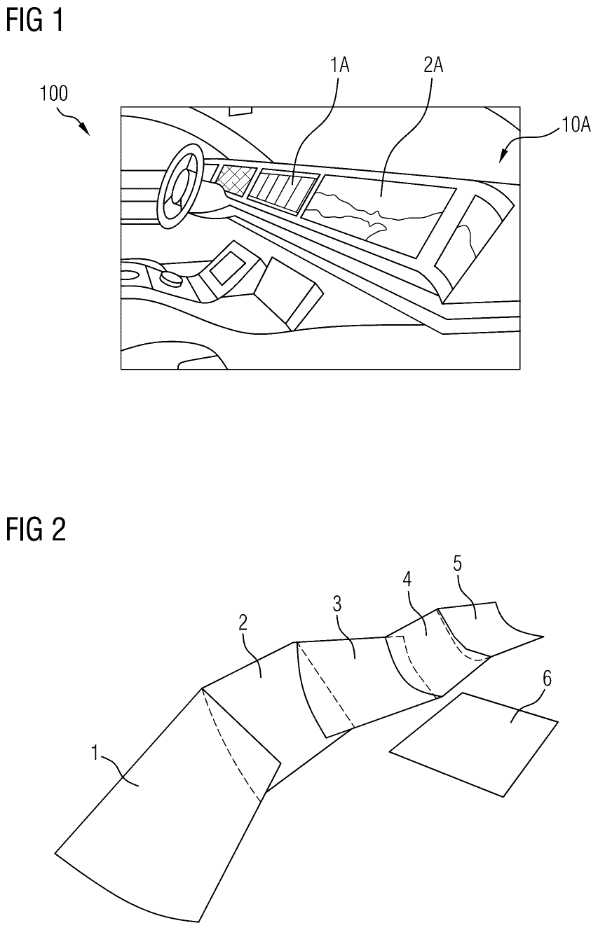

FIG. 1 shows an exemplary setup of a multi display arrangement 10A in a vehicle 100 according to prior art, where display units 1A, 2A usually are placed side by side. Often, several display units are placed behind a single display glass and are typically of rectangular shape. Such display glass is preferably made of glass but may also be made of other transparent material as polymethylmethacrylate (PMMA) or other transparent plastics.

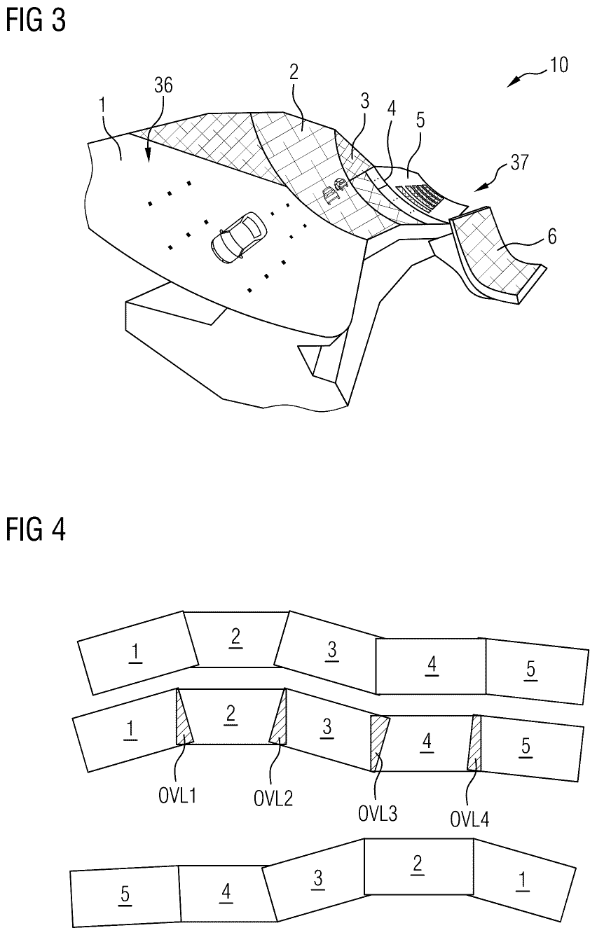

FIG. 2 shows an exemplary display integration according to the invention using flexible OLED (Organic Light Emitting Diode) display units 1, 2, 3, 4, 5 from a perspective view. The shown exemplary inventive concept idea is that each display unit 1, 2, 3, 4, 5 has the same standardized format, but looks different from display unit 1, 2, 3, 4, 5 to display unit 1, 2, 3, 4, 5 due to the overlapping positioning to each other. By doing so 3-dimensional shapes of multi display arrangements 10 (see e.g., FIG. 3 or FIG. 8) are made possible. An optional non-overlapping display unit 6 is also represented at the right side of the figure and may be suitable e.g., for an enlargement of the multi display arrangement 10. By showing the dotted lines in this figure it is shown that rectangular display units 1, 2, 3, 4, 5 are used.

Similar to FIG. 2, the integration of display units 1, 2, 3, 4, 5 behind one single (3-dimenisonally shaped) cover glass 36 is shown in FIG. 3, so that the appearance of the final product looks like one single component. The end user will not see the various areas of overlapping display units 1, 2, 3, 4, 5 and gets an extremely variable display layout and placement impression. However, according to the invention only one single display unit size is used. The figure shows one possibility of the display units' 1, 2, 3, 4, 5 positioning. The additional, non-overlapping display unit 6 has a curved shape in the embodiment shown here. For example, at least one of the display units 1, 2, 3, 4, 5, 6 can be built as bent OLED panel 37.

FIG. 4 shows an exemplary setup of the multi display arrangement 10. In the upper part a front view and in the middle part of the figure the front view with hatched lines indicating the overlapping areas OVL1, OVL2, OVL3, and OVL4 is shown. In the lower part of the figure the back view with display unit 2 overlapping display unit 1 and display unit 3 is shown. The display unit numbers 1 to 5 do not necessarily correspond to an intended assembly order and are therefore only shown as illustrative examples. During assembly, display unit 1 and display unit 4 are placed first, as they have no overlap to each other. This means, their complete area is visible as can be seen in the upper part of the figure. After that, in a following manufacturing step, display unit 3 and display unit 5 are placed resulting in overlapping area OVL3 and overlapping area OVL4. This results in display unit 4 overlapping two display units which are display units 3 and 5. Display unit 2 is then placed last and is overlapped by the two display units 1 and 3 at the same time, if viewed from the front, which also can be seen in the upper part of the figure. The overlapping display units 1, 2, 3, 4, 5 have, in a preferred embodiment, no direct contact with an aluminum cooling surface which is built as at least one aluminum plate 71 (clearly shown in FIG. 16) that is preferably arranged in the overlapping areas OVL1 to OVL4 or in general at the back 53 of the display units 1, 2, 3, 4, 5 that is opposite to the cover glass 36. The space between the back 53 and the aluminum plate is preferably filled with thermal adhesive TA (see FIG. 16), thus providing indirect thermal contact as well as compensation of different shapes.

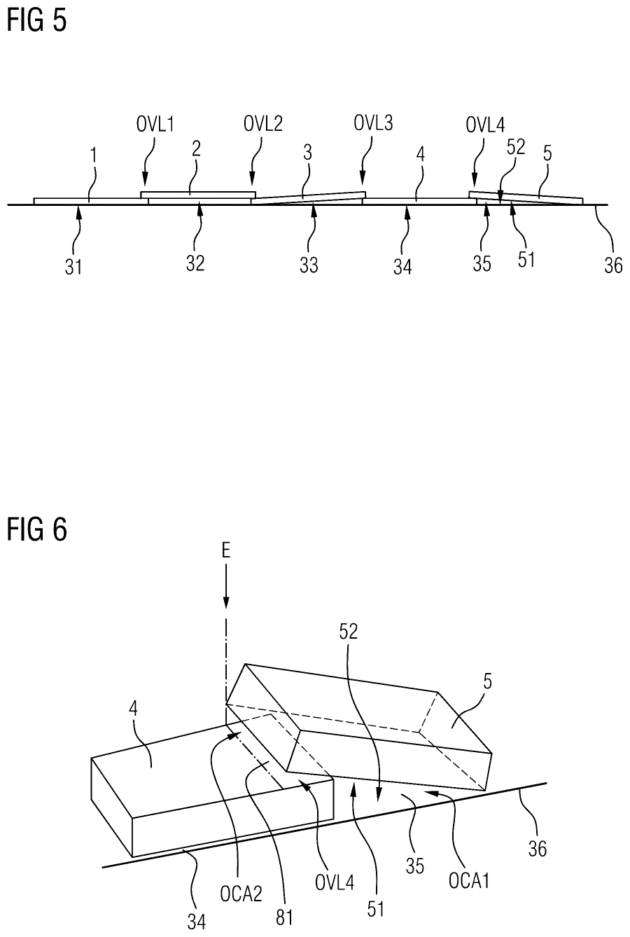

In FIG. 5 a stack up of display units 1, 2, 3, 4, 5 with the cover glass 36 is shown from a top view, where the upper side edges of the display units 1 to 5 are shown as a bold line. It can be seen that the display units 1, 2, 3, 4, 5 are thin. The areas 31 to 35 that are visible between cover glass 36 and display units 1 to 5, respectively, are filled with optically clear resin, also referred to as OCR, or with optically clear adhesive, also referred to as OCA (shown in FIG. 6).

These types of adhesives are best suitable for optical bonding applications as e.g., the proposed multi display arrangement 10 with its multiple display units 1, 2, 3, 4, 5, as they enable free form and curved display designs in automotive and other electronic devices. They show high transparency and strong contact bonding properties which make electronic advancements with touch screen displays possible. Using this bonding technology enhances display performance by improving sunlight readability up to 400%. Furthermore, it is ideal for use in consumer and industrial applications requiring a durability to withstand impact, vibration, extreme temperatures, altitudes, and dust.

The areas 31 to 35 which are filled with optical clear resin/adhesive show various shapes depending on the position of the respective display unit 1, 2, 3, 4, 5 in the multi display arrangement 10. The areas 31 to 35 show therefore individual shapes of the e.g., cuboid, rectangle, or trapezoidal format.

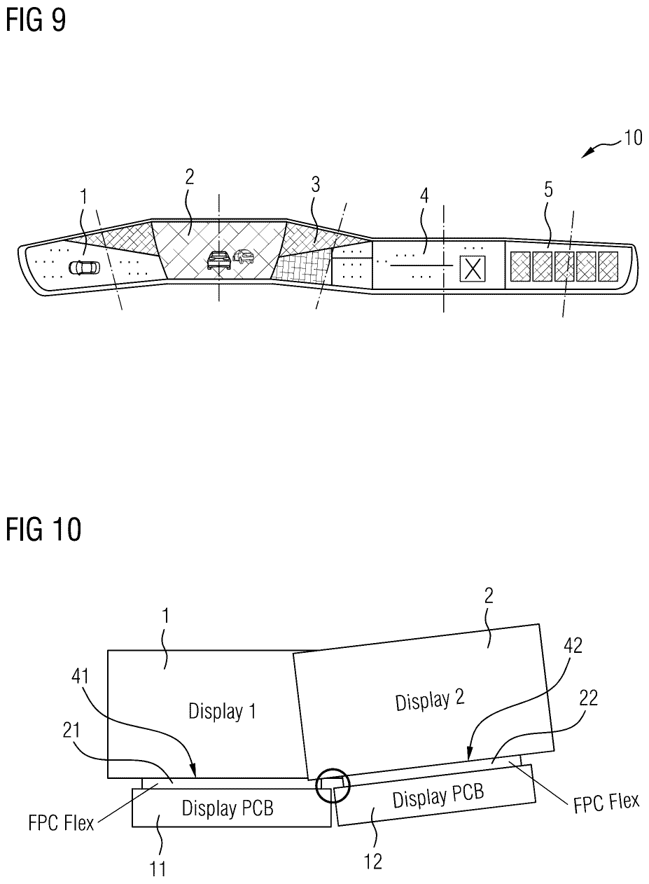

The overlapping areas OVL1 to OVL4 are provided with special integration for good heat transfer. Lamination of the overlapping areas OVL1 to OVL4 requires special attention. An assembly process using liquid OCR or OCA with same or different thicknesses and/or density is used. The display area of the overlapping display units 1 to 5 is individually reduced, specified by the request of needed content and/or information for which the multi display arrangement 10 is thought for. The overall number of available pixels is less than the sum of the pixels of each display unit 1 to 5. The UI (User Interface) design is challenging depending on the respective angle between two display units 1, 2, 3, 4, 5. Thus, the UI for neighboring display unit pairs 1,2; 2,3; 3,4; 4,5 is preferably rotated to be horizontal again (see FIG. 9).

OLED displays heat up when displaying bright colors. Due to the overlaps OVL1, OVL2, OVL3, OVL4, the heat source in these areas is doubled. In addition, the respective overlapped display has no direct contact with the cooling surface in the area of the overlap. Therefore, to avoid overheating, the entire display is cooled by at least one aluminum plate 71 (see FIG. 16). The distances to the cooling surface are connected/filled with heat- conducting paste (not shown in the figures) and/or thermal adhesive (see FIG. 16). Furthermore, black is displayed in the area of the overlap, in the display behind it. Black consumes little or no electricity in an OLED and therefore in these areas no heat is generated.

For every display pair 1,2; 2,3; 3,4; 4,5 at least one bending axis is possible. If—e.g. due to a desired/requested design of the multi display arrangement 10—more bending axes are needed/intended, then the bending axes must fulfil the requirement that the at least first virtual crossing of the axes is placed outside of the multi display arrangement 10 or that there is no crossing at all.

Display units 1, 2 and 4 are arranged parallel to the cover glass 36. This allows an application of either a fluid, a hybrid, or a film OCA in the gaps 31, 32 and 34. In this embodiment a film OCA is the simplest way to do it. A film transparent adhesive is of thickened consistence like “chewing gum” and has preferably a thickness of 50 μm to 500 μm depending on the application it is thought for. Also larger thicknesses are possible, or two or more layers of film transparent adhesives are stacked if a larger thickness is desired. Film adhesives does not work at angles like e.g., gaps 33 and 35. For these non-parallel gaps fluid or hybrid OCA is suitable.

The individual distance between display units 1, 2, 3, 4, 5 and cover glass 36 varies depending on the used type of display units 1, 2, 3, 4, 5. In a preferred embodiment a maximum distance is below 1,5 mm, preferably between 0,9 mm and 1,3 mm. In the case of one-sided overlaps, the gap increases from 0,2 mm up to the thickness of the chosen display units.

FIG. 6 shows an example of a possible arrangement of two display units 4 and 5 on a cover glass 36. The shown overlap of display units 4 and 5 results in different distances from the respective display surfaces 51 to the back 52 of the cover glass 36 as they are laid on top of each other at an angle. The individual distance of the display units 4 and 5 must be compensated as described in FIG. 5 by the optical clear adhesives OCA1 which is in this example filled in gaps 34 and 35.

The angled overlap area OVL4 is filled with a fluid or hybrid clear adhesive OCA2 and builds a gap 81 between display units 4 and 5. The gap 81 is not visible from a viewing point E which line of sight is rectangular to the cover glass 36 and the hereto parallel arranged display unit 4. Due to the optical clear adhesive OCA2 filled in the gap 81 the arrangement appears to the viewer of the overlapping display pair 4,5 as one single unit.

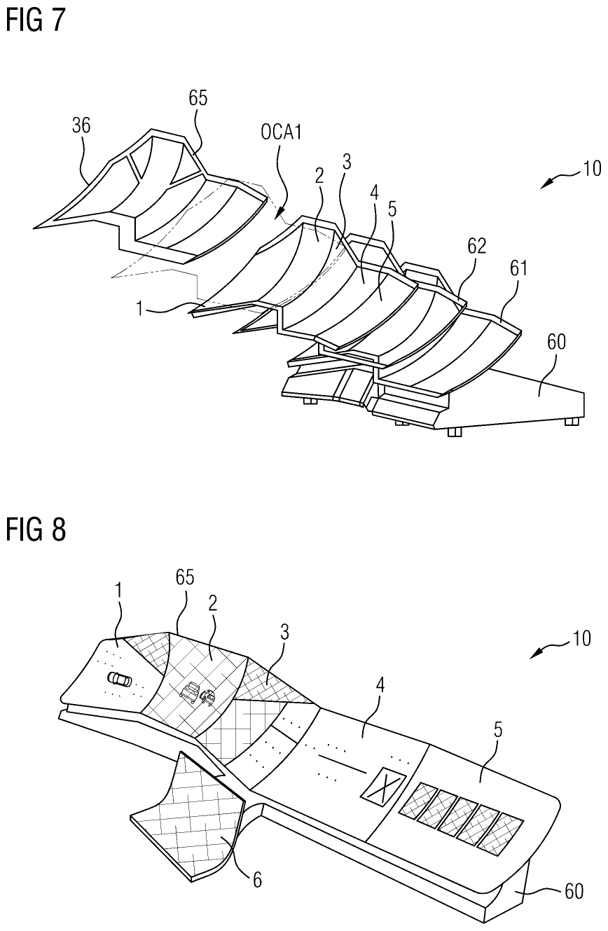

FIG. 7 shows a 3-dimensional (3-D) exploded view of a multi-display arrangement 10 according to the invention. On a support structure 60 a display stack holder 61 is arranged. On display stack holder 61 a display glass frame 62 is arranged. Within the space surrounded by the display glass frame 62 the display units 1, 2, 3, 4, 5 are arranged. In this view, the display units 1 to 5 are already stacked, and optically clear adhesive or optically clear resin is provided where appropriate. In addition, or alternatively, a layer of optically clear adhesive OCA1 is arranged between the cover glass 36 and the display units 1 to 5. The display cover glass 36 is provided with areas of black print 65. These areas may differ in shape and size depending on the needed purpose and requested content of the multi display arrangement 10 as such. In the example shown here, at least one of the display units 1 to 5 is provided with touch sensor functionality.

FIG. 8 shows an example of how a final product may look like. The appearance and design language shows different display sizes and display orientations. According to the invention this is made possible with using a single display unit size due to the inventive idea of overlapping display units 1 to 5. In the shown embodiment of the invention the areas of black print 65 covering display units 1 to 3 are distributed in a symmetrically shape, this e.g., could be of interest in an in-car application where information from outside the car which is given from both sides could be provided very close to the driver's eyes.

In FIG. 9 it can be seen that the user interface, also referred to as UI, is adjusted to the orientation (2-D angels shown by dotted lines) of the display units 1 to 5. Especially the angle between the display units 1 to 5 due to various bending axes to realize a 3-D shape of the multi display arrangement 10 is corrected in the UI-Pictures displayed on the respective display units 1 to 5. In general, displays have a 2-dimensional structure. Pixel lines are at right angles or parallel to the external dimensions of the display.

Depending on the arrangement of the display units 1, 2, 3, 4, 5, the orientation from display to display is shifted or twisted. Two displays parallel to each other have no displacement. If a display is now shifted at an angle of e.g., 45 degrees (not shown in the figure), the pixel lines are also at an angle to each other. Therefore, this needs to be corrected in the user interface UI to provide a “normal” view on the multi display arrangement 10 for the user.

FIG. 10 shows an example for a possible overlap of display unit pair 1,2 with a display PCB 11 connected by a Flexible Printed Circuit (FPC) FPC 21 at a connecting side 41 of the display unit 1 which is partly arranged in the back of display unit 2 with a PCB 12 connected by a FPC 22 at a connecting side 42 of display unit 2. As it can be seen neither the FPCs 21 and 22 nor the PCBs 11 and 12 are overlapping each other (indicated by a circle). Therefore, the display pair 1,2 is bendable.

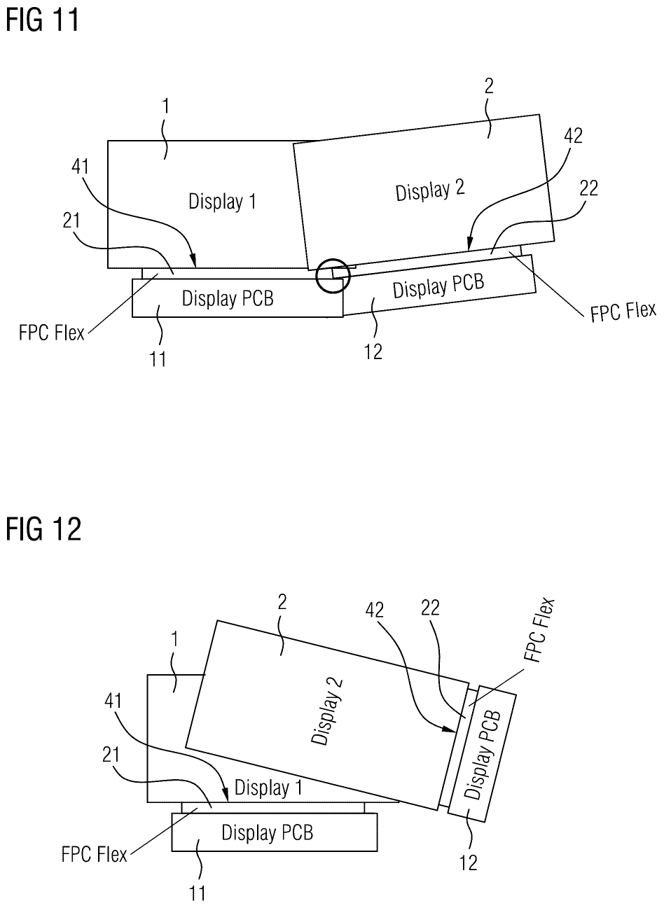

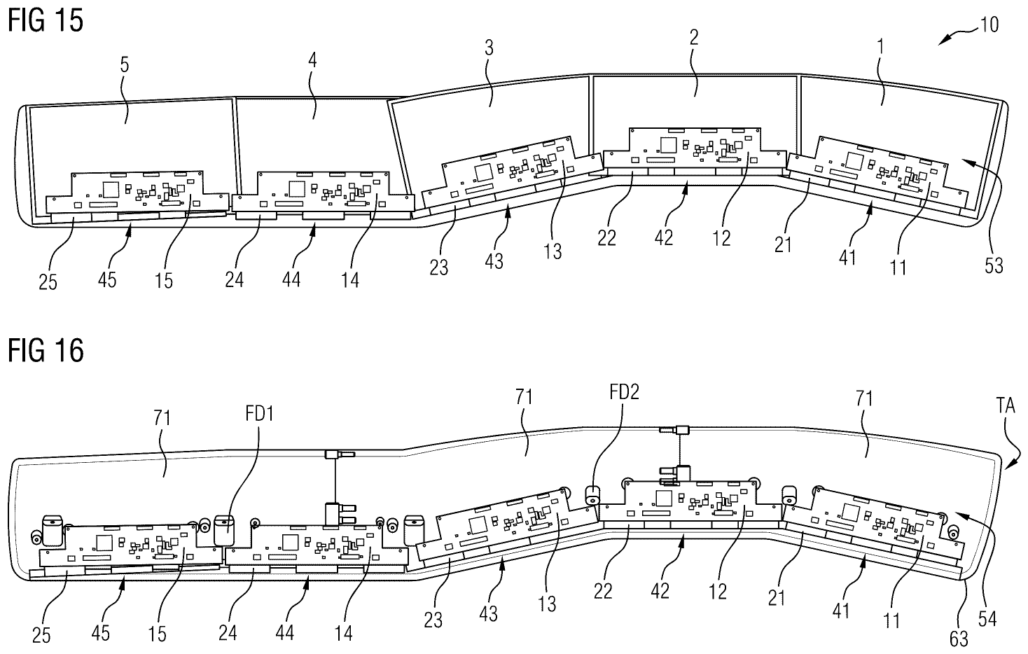

FIG. 11 shows an example for a non-working overlap for a 3-D lamination. This is due to display unit's 1 overlap of FPC 22 of display unit 2 (indicated by a circle). This means that the PCB 12 of display unit 2 cannot move freely after lamination because it is partly stuck under display unit 1. In general, according to the invention each FPC is the connection between a display PCB and the PCB itself. Usually, the display PCBs are bent around the display unit after lamination as can be seen in FIGS. 15 and 16.

FIG. 12 shows a further example for a working overlap. in this embodiment two different display units 1 and 2 are used. Display unit 2 is overlapping display unit 1. Neither FCBs 21 and 22 nor PCBs 11 and 12 are overlapping each other. Also no one of the display units 1 or 2 is overlapping a FCB or PCB of the other display unit 1 or 2. Therefore, this arrangement can be laminated.

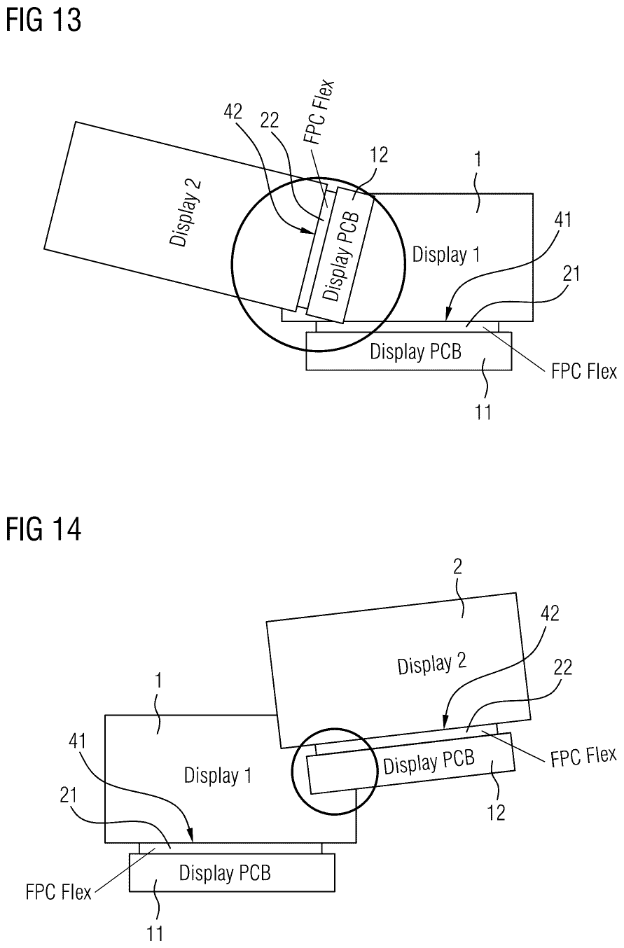

FIG. 13 shows another example for a non-working overlap for a 3-D lamination. In this example display unit 2 is overlapping display unit 1. In this embodiment the PCB 12 of display unit 2 is blocked (indicated by a circle). During the lamination process it therefore cannot be moved freely out of the bending area which results in that a 3-D lamination for such constellation is not possible.

FIG. 14 shows a further example for a non-working overlap. Display unit 2 is overlapping display unit 1 and the PCB 12 of display unit 2 is blocked (overlapped) by display unit 1. Therefore, during the lamination process PCB 12 also cannot be moved.

FIG. 15 shows a rear view of the multi display arrangement 10 with display units 1, 2, 3, 4, 5 and PCBs 11, 12, 13, 14, 15 and FPCs 21, 22, 23, 24, 25 arranged at a back side 53 of the display units 1, 2, 3, 4, 5. At each connecting side 41, 42, 43, 44, 45 of the respective display unit 1, 2, 3, 4, 5 the FPCs 21, 22, 23, 24, 25 serve as connection to the respective PCBs 11, 12, 13, 14, 15. These are on surface 51 and backside 53 of the respective display unit 1, 2, 3, 4, 5 preferably attached by using a thermal bonding process e.g., ACF-bonding (Anisotropic Conductive Film) which is a process of creating electrically conductive adhesive bonds between flexible and rigid circuit boards, glass panel displays and flex foils with very fine pitch.

FIG. 16 shows a rear view of the multi display arrangement 10 where a its backside 54 aluminum cooling plates 71 are arranged. In the shown example three aluminum plates 71 are arranged. This is just exemplary. In other embodiments of the invention there can also be used only one or two or even more than three. This is always depending on e.g., the size, the purpose and/or the intended application area of the proposed multi display arrangement 10. The space between the backside 53 of the display units 1, 2, 3, 4, 5 and the aluminum plate 71 is filled with the thermal adhesive TA as already mentioned in FIG. 4. On the at least one aluminum plate 71 there is arranged a plurality of fastening devices FD1 and FD2. FD1s for a fastening parallel to the aluminum plate 71 and FD2s for a fastening rectangular to the aluminum plate 71. All fastening devices are intended for a fastening of the at least one aluminum plate 71 to the support structure 60 (FIG. 7). In this embodiment the complete multi display arrangement 10 is covered by a plastic frame 63. This is due to increase the multi display arrangement's 10 stability.

For the skilled person in the art, it is understood that a multi display arrangement 10 according to the invention is not limited to five display units.

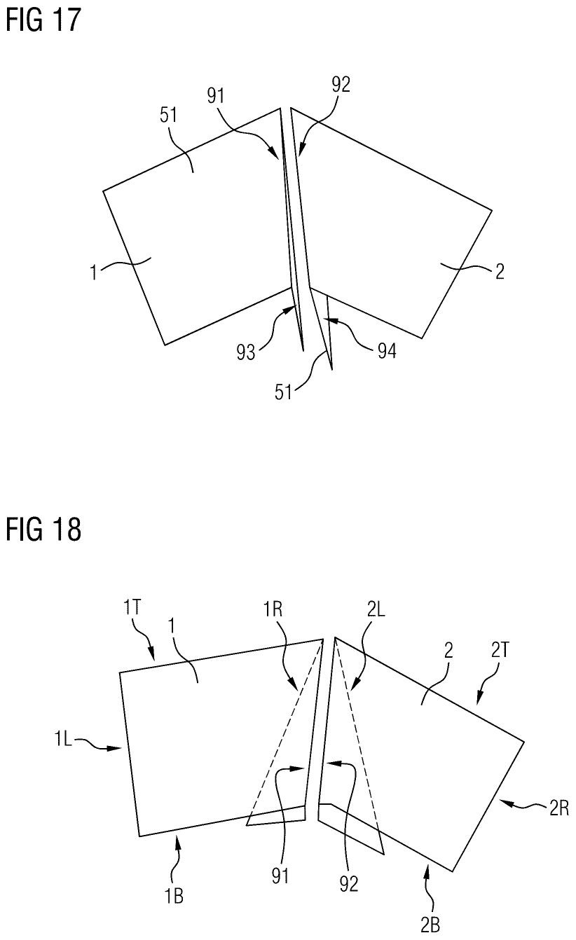

In an alternative solution the display units 1 and 2 are not arranged with overlap but are bent or folded around, e.g., by 90°, to get a new outline. This is diagrammatically shown in FIG. 17 and FIG. 18.

FIG. 17 shows a display unit 1 being bent along bending line 91. As can be seen, the bending angle is about 90°. Another display unit 2 is bent along bending line 92. The display units 1, 2 are arranged next to each other and joined along their respective bending lines 91, 92. Alternatively the bent part 93 of display unit 1 and the bent part 94 of display unit 2 can be cut to reduce volume. Display unit 1 has a surface 51 that is arranged at least partly with a lower distance to an adjacent surface 52 of a cover glass 36 (not shown here) than a respective surface 51 of the other display unit 2 in the bent part 94.

FIG. 18 shows a display unit 1 being bent along bending line 91. As can be seen, the bending angle is about 180°. Thus, the overall thickness is rather small. Another display unit 2 is bent along bending line 92. The display units 1, 2 are arranged next to each other and joined along their respective bending lines 91, 92. The top boundary 1T, the bottom boundary 1B and the left boundary 1L of the display unit 1 are visible, while the right boundary 1R is indicated by dotted line as it is hidden by the visible area of the display unit 1. The top boundary 2T, the bottom boundary 2B and the right boundary 2R of the other display unit 2 are visible, while the left boundary 2L is indicated by dotted line as it is hidden by the visible area of the display unit 2.

### Reference List

1 display unit
1A display unit (prior art)
2 display unit
2A display unit (prior art)
3 display unit
4 display unit
5 display unit
6 display unit
10 multi display arrangement
10A multi display arrangement (prior art)
11 PCB (of display unit 1)
12 PCB (of display unit 2)
13 PCB (of display unit 3)
14 PCB (of display unit 4)
15 PCB (of display unit 5)
21 FPC (between display 1 and PCB 11)
22 FPC (between display 2 and PCB 12)
23 FPC (between display 3 and PCB 13)
24 FPC (between display 4 and PCB 14)
25 FPC (between display 5 and PCB 15)
31 area (visible between cover glass 36 and display unit 1)
32 area (visible between cover glass 36 and display unit 2)
33 area (visible between cover glass 36 and display unit 3)
34 area (visible between cover glass 36 and display unit 4)
35 area (visible between cover glass 36 and display unit 5)
36 cover glass
37 OLED panel
41 connecting side (of display unit 1)
42 connecting side (of display unit 2)
43 connecting side (of display unit 3)
44 connecting side (of display unit 4)
45 connecting side (of display unit 5)
51 surface (of a display unit 1, 2, 3, 4, 5 towards the cover glass 36)
52 surface (of the over glass 36 towards a display unit 1, 2, 3, 4, 5)
53 backside (of a display unit 1, 2, 3, 4, 5 towards the aluminum plate 71)
54 backside (of the multi display arrangement 10)
60 support structure
61 stack holder
62 glass frame
63 plastic frame
65 black print
71 aluminum plate
81 gap (built by overlapping areas (OVL1, OVL2, OVL3, OVL4) between display units (1, 2, 2, 3, 4,5)
91 bending line (of display unit 1)
92 bending line (of display unit 2)
93 bent part (of display unit 1)
94 bent part (of display unit 2)
100 vehicle
1B bottom boundary (of display unit 1)
1L left boundary (of display unit 1)
1R right boundary (of display unit 1)
1T top boundary (of display unit 1)
2B bottom boundary (of display unit 2)
2L left boundary (of display unit 2)
2R right boundary (of display unit 2)
2T top boundary (of display unit 2)
E viewing point (with axis rectangular to surface of display unit 4/cover glass 36)
FD1 fastening device 1 (in the axis of the aluminum plate 71)
FD2 fastening device 2 (rectangular to the aluminum plate 71)
OCA1 optically clear adhesive/resin (between display surface 51 and adjacent cover glass surface 52)
OCA2 optically clear adhesive/resin (in gaps 81)
OVL1 overlapping area
OVL2 overlapping area
OVL3 overlapping area
OVL4 overlapping area
TA thermal adhesive (between display surfaces 53 and aluminum plate 71)

1. A multi display arrangement, with at least two display units , wherein a pair of said display units consists of thin display units that are arranged in an overlapping manner, and wherein the display units are optically bonded to a cover glass, and wherein at least one of said display units has a surface that is arranged at least partly with a larger distance to an adjacent surface of the cover glass than a respective surface of a respective other display unit.

2. The multi display arrangement according to claim 1, wherein at least one of said display units has a surface that is arranged non-parallel to an adjacent surface of the cover glass.

3. The multi display arrangement according to claim 1, wherein a space between display surface and adjacent cover glass surface is filled at least partly with cured liquid optically clear adhesive material.

4. A multi display arrangement, with at least two display units, characterized in that a pair of said display units consists of thin display units that are each bent and arranged next to each other along their respective bending lines.

5. The multi display arrangement according to claim 1, wherein at least one of said display units is a bendable OLED panel.

6. The multi display arrangement according to claim 1, wherein an aluminum plate is arranged at a backside of a display unit.

7. The multi display arrangement according to claim 1, wherein overlapping areas between display units define a gap and wherein said gap is filled at least partly with cured liquid optically clear adhesive material.

8. The multi display arrangement according to claim 1, wherein each display unit is provided with a printed circuit board (PCB) attached at a connecting side of said display unit via a flexible printed circuit (FPC), wherein said PCB is arranged at the backside of said display unit via said FPC being bent, and wherein a pair of display units is arranged overlapping such that their respective PCBs would not overlap if they were bent back to lie in the same plane as their respective display unit.

9. The multi display arrangement according to claim 1, wherein each display unit is provided with a printed circuit board (PCB) attached at a connecting side of said display unit via a flexible printed circuit (FPC), wherein said PCB is arranged at the backside of said display unit via said FPC being bent, and wherein a pair of display units is arranged overlapping such that their respective PCBs would not overlap with the respective other display unit of said pair if they were bent back to lie in the same plane as their respective display unit.

10. An apparatus comprising a multi display arrangement, with at least two display units, wherein a pair of said display units consists of thin display units that are arranged in an overlapping manner and wherein the display units are optically bonded to a cover glass, and wherein at least one of said display units has a surface that is arranged at least partly with a larger distance to an adjacent surface of the cover glass than a respective surface of a respective other display unit.

11. A vehicle comprising an apparatus comprising a multi display arrangement, with at least two display units, wherein a pair of said display units consists of thin display units that are arranged in an overlapping manner, and wherein the display units are optically bonded to a cover glass, and wherein at least one of said display units has a surface that is arranged at least partly with a larger distance to an adjacent surface of the cover glass than a respective surface of a respective other display unit.
